(19) United States
(12) Patent Application Publication
(10) Pub. No.: US 2025/0177918 A1
(43) Pub. Date: Jun. 5, 2025

(54) DENITRATION CATALYST STRUCTURE

(71) Applicant: MITSUBISHI HEAVY INDUSTRIES, LTD., Chiyoda-ku, Tokyo (JP)

(72) Inventors: Keiichiro Kai, Chiyoda-ku, Tokyo (JP); Takuma Kurai, Chiyoda-Ku, Tokyo (JP); Yu Urabe, Chiyoda-Ku, Tokyo (JP); Hiroyuki Yoshimura, Chiyoda-Ku, Tokyo (JP)

(73) Assignee: MITSUBISHI HEAVY INDUSTRIES, LTD., Chiyoda-ku, Tokyo (JP)

(21) Appl. No.: 18/844,239

(22) PCT Filed: Mar. 13, 2023
(86) PCT No.: PCT/JP2023/009659

§ 371 Date: Sep. 5, 2024

(30) Foreign Application Priority Data
Mar. 11, 2022 (JP) 2022-038685

(51) Int. Cl. B01D 53/86; B01D 53/88; B01J 23/28; B01J 23/30; B01J 35/54

(52) U.S. Cl. CPC B01D 53/8631; B01D 53/885; B01J 23/28; B01J 23/30; B01J 35/54; B01D 2255/20707; B01D 2255/20723; B01D 2255/20769; B01D 2255/20776; B01D 2257/404; B01D 2258/0283

(57) ABSTRACT

A denitration catalyst structure includes: a rectangular frame body having a gas inlet and a gas outlet; a plurality of plate-like catalytic elements each of which has a gas inlet-side edge, a gas outlet-side edge, and two side edges and contains a catalytic component; and a plate-like draft stopper having a gas inlet-side edge, a gas outlet-side edge, and two side edges. The plurality of plate-like catalytic elements are stacked and housed in the frame body with the side edges aligned, with a space between the stacked plate-like catalytic elements and between an inner surface of the frame body and the side edges of each plate-like catalytic element to allow a gas to pass from the gas inlet to the gas outlet through the space. The plate-like draft stopper is arranged between the inner surface of the frame body and the side edges of each plate-like catalytic element.

### TECHNICAL FIELD

The present invention relates to a denitration catalyst structure. In more detail, the present invention relates to a denitration catalyst structure that can achieve a high denitration rate by hindering the flow of gas passing between the inner surface of the frame body and the side edges of each plate-like catalytic element without stopping it to improve the contact efficiency with catalytic components.

### BACKGROUND

Nitrogen oxides in the gas emitted from furnaces of boilers in thermal power plants and various factories and furnaces of refuse incinerators are decomposed in the presence of denitration catalysts to purify the exhaust gas. Various types of denitration catalyst structures have been proposed for highly efficient decomposition of nitrogen oxides in the exhaust gas.

For example, Patent Document 1 discloses a catalyst retainer interposed between a carrier carrying a catalyst for exhaust gas purification and an exhaust pipe surrounding the carrier for holding the carrier, comprising: an inorganic fiber mat for heat dissipation which is mixed with a material having higher thermal conductivity than the inorganic fiber and arranged in a position contacting an intermediate portion of the carrier along the exhaust gas flow direction; and an inorganic fiber mat for preventing exhaust gas from blowing through which is not mixed with said material and is arranged upstream or downstream of the heat dissipation mat, in which said material is exposed on the outer surface of the heat dissipation mat, and the pressure on the contact surface between the heat dissipation mat and the exhaust pipe increases as the temperature rises.

Patent Document 2 discloses a catalyst carrier module comprising: a can of a rectangular tube shape having an inlet and an outlet; a cell forming body in which a plurality of hollow cells are formed by alternately laminating a wave plate and a flat plate which are coated with a catalyst on a surface thereof and inserted into the can; and a fixing unit installed at the inlet and the outlet of the can to prevent the cell forming body from detaching from the can.

Patent Document 3 discloses a denitration reactor comprising: a plate-like catalyst arranged parallel to the exhaust gas flow and in the direction of gravity; a catalyst unit containing a plurality of the plate-like catalysts, and a reaction vessel containing a plurality of the catalyst units, in which the plate-like catalysts are supported by contacting inwardly inclined surfaces at the exhaust gas inlet and outlet horizontal portions of the catalyst unit with the end portions of the plate-like catalysts.

### CITATION LIST

### Patent Literature

Patent Document 1: JP2014-105683A
Patent Document 2: JP2019-511953A (translation of a PCT application)
Patent Document 3: JPH8-187434A

### SUMMARY

### Problems to be Solved

To hinder the flow of gas through the space between the inner surface of the frame body and the side edges of each plate-like catalytic element, one might consider filling the space completely with something, but this would greatly increase ventilation losses due to the smaller cross-sectional area of the passage. If the space is filled with fiber clumps, since the elasticity of fiber clumps such as rockwool is low, the plate-like catalytic elements tend to be biased to one side within the frame body after the denitration catalyst structure is assembled. A bias toward one side widens the space on the other side.

An object of the present invention is to provide a denitration catalyst structure that can achieve a high denitration rate by hindering the flow of gas passing between the inner surface of the frame body and the side edges of each plate-like catalytic element without stopping it to improve the contact efficiency with catalytic components.

### Solution to the Problems

As a result of studies to solve the above problems, the inventors have come to complete the present invention, which encompasses the following embodiments.

(1) A denitration catalyst structure, comprising: a rectangular frame body having a gas inlet and a gas outlet; a plurality of plate-like catalytic elements each of which has a gas inlet-side edge, a gas outlet-side edge, and two side edges and contains a catalytic component; and a plate-like draft stopper having a gas inlet-side edge, a gas outlet-side edge, and two side edges. The plurality of plate-like catalytic elements are stacked and housed in the frame body with the side edges aligned, with a space between the stacked plate-like catalytic elements and between an inner surface of the frame body and the side edges of each plate-like catalytic element to allow a gas to pass from the gas inlet to the gas outlet through the space. The plate-like draft stopper is arranged between the inner surface of the frame body and the side edges of each plate-like catalytic element so that a plate surface of the plate-like draft stopper follows the inner surface of the frame body, and the plate-like draft stopper has a mechanism which hinders a flow of the gas passing between the inner surface of the frame body and the side edges of each plate-like catalytic element without stopping the flow.

(2) A denitration catalyst structure as defined in (1), in which the plate-like draft stopper contains a catalytic component.

(3) A denitration catalyst structure as defined in (1) or (2), in which the mechanism which hinders the flow of the gas without stopping the flow is ridges arranged non-parallel to a gas flow direction on the plate surface of the plate-like draft stopper.

### Advantageous Effects

The denitration catalyst structure of the present invention can achieve a high denitration rate by hindering the flow of gas passing between the inner surface of the frame body and the side edges of each plate-like catalytic element without stopping it to improve the contact efficiency with catalytic components. The denitration catalyst structure of the present invention can be suitably used in the removal of nitrogen oxides produced by the combustion of coal fuel, gas fuel, ammonia fuel, etc.

In the denitration catalyst structure of the present invention, the plate-like draft stopper has the mechanism on the plate surface which hinders the flow of gas without stopping it. This mechanism hinders the flow of gas passing between the inner surface of the frame body and the side edges of each plate-like catalytic element without stopping it, thereby reducing the amount of gas that passes without touching the plate-like catalytic elements. Since the plate-like draft stopper does not completely fill the space, the reduction in gas inlet opening area is small, and the increase in ventilation losses is low. If the plate-like draft stopper contains a catalytic component, the denitration reaction can proceed on its surface. If the plate-like draft stopper is sufficiently elastic, the plate-like catalytic elements are prevented from being biased to one side within the frame body.

### BRIEF DESCRIPTION OF DRAWINGS

FIG. 1 is a perspective view showing an example of a denitration catalyst structure according to the present invention.

FIG. 2 is a perspective view showing an example of a frame body.

FIG. 3 is a perspective view showing an example of a plate-like catalytic element.

FIG. 4 is a perspective view showing an example of a plate-like catalytic element.

FIG. 5 is a perspective view showing an example of a plate-like draft stopper.

FIG. 6 is a perspective view showing an example of a plate-like draft stopper.

FIG. 7 is a perspective view showing an example of assembly of plate-like catalytic elements A, B and plate-like draft stoppers C, D within a frame body.

FIG. 8 is top, front and side views of the plate-like catalytic element shown in FIG. 4.

FIG. 9 is top, front and side views showing an example of a plate-like catalytic element.

FIG. 10 is top, front and side views showing an example of a plate-like catalytic element.

FIG. 11 is a top perspective view showing an example of assembly of plate-like catalytic elements A1, B1 and plate-like draft stoppers C, D within a frame body 5.

### DETAILED DESCRIPTION

Embodiments of the present invention will specifically be described with reference to the accompanying drawings. However, the scope of the present invention is not limited by the following embodiments.

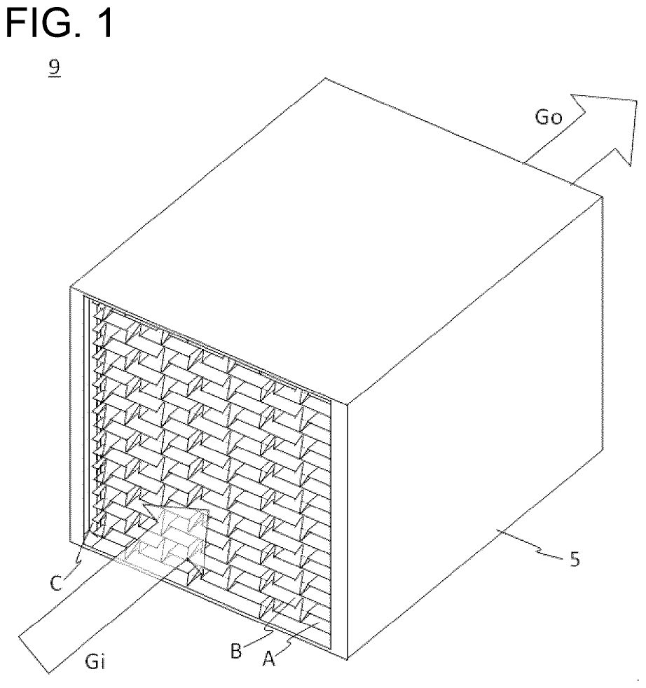

In an embodiment of the present invention, the denitration catalyst structure includes a frame body 5, a plurality of plate-like catalytic elements A, B, and plate-like draft stoppers C, D. In FIG. 1, the plate-like draft stopper D is hidden behind the right side surface of the frame body 5.

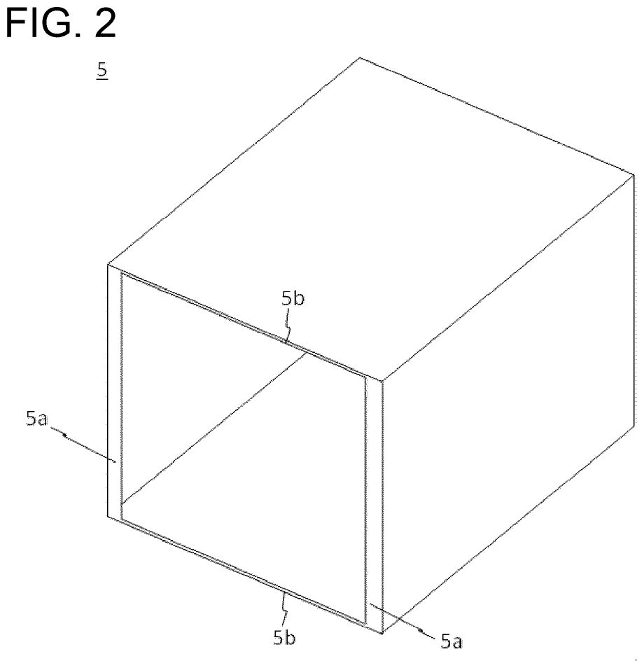

The frame body is rectangular in shape and has a gas inlet and a gas outlet. The upper surface, lower surface, right side surface, and left side surface of the frame body are preferably designed such that the inflowing gas does not leak out (for example, they are flat plates in FIG. 2). The frame body is preferably made of metal from the viewpoints of heat resistance and mechanical strength. The edges of the inlet or/and outlet of the frame body are preferably edge-treated. The edge treatment includes folding (hemming), edge wrapping, and L-shaped bending (e.g., flange forming). The edge treatment improves the strength of the frame body. The frame body 5 shown in FIG. 2 has hemmings 5b on the upper and lower edges and flanges 5a on the right and left side edges. Each flange 5a is bent inward on the frame body. By designing the size of the flange to correspond to the size of the space formed between the inner surface (right or left side surface) of the frame body and the side edges of each plate-like catalytic element, it is expected to have the effect of partially obstructing the flow of gas passing between the inner surface of the frame body and the side edges of each plate-like catalytic element.

Each plate-like catalytic element is plate-shaped with a gas inlet-side edge, a gas outlet-side edge, and two side edges. The overall shape of the plate-like catalytic element is preferably square or rectangular.

The plate-like catalytic element contains a catalytic component. The method of containing the catalytic component is not limited. For example, the plate-like catalytic element is preferably composed of a plate base material and a catalytic component carried on the surface thereof. Examples of the plate base material include lath plates, inorganic fiber woven fabrics, and inorganic fiber non-woven fabrics. Expanded metal, perforated metal, and wire mesh can be used as the lath plates. The catalytic component can be carried by impregnation, coating, pressing, etc. The catalytic component is preferably carried on the plate base material so that the mesh of the plate base material, such as expanded metal, is blocked.

The catalytic component is not limited as long as it has a denitration catalytic effect. Examples thereof include components (titanium-based catalysts) containing oxides of titanium, oxides of molybdenum and/or tungsten, and oxides of vanadium; components (zeolite-based catalysts) containing mainly aluminosilicate such as zeolite with a metal such as Cu or Fe supported; and components obtained by mixing the titanium-based catalysts and zeolite-based catalysts. Among them, titanium-based catalysts are preferred.

Examples of the titanium-based catalysts include Ti-V-W catalyst, Ti—V—Mo catalyst, and Ti-V-W-Mo catalyst.

The ratio of V element to Ti element is preferably not more than 9 wt %, more preferably not more than 3 wt % as a weight percentage of V₂O₅/TiO₂. The ratio of Mo and/or W element to Ti element is preferably not more than 20 wt %, more preferably not more than 5 wt % as a weight percentage of (MoO₃+WO₃)/TiO₂ when oxides of molybdenum and tungsten are used together.

In the preparation of titanium-based catalysts, titanium dioxide powder or titanium dioxide precursors can be used as raw materials for oxides of titanium. Examples of the titanium dioxide precursors include titanium dioxide slurries, titanium dioxide sols; titanium sulfate, titanium tetrachloride, titanate, and titanium alkoxide. In the present invention, anatase titanium dioxide is preferably used as raw materials for oxides of titanium.

Vanadium compounds such as vanadium pentoxide, ammonium metavanadate, and vanadyl sulfate can be used as raw materials for oxides of vanadium.

Ammonium paratungstate, ammonium metatungstate, tungsten trioxide, and tungsten chloride can be used as raw materials for oxides of tungsten.

Ammonium molybdate and molybdenum trioxide can be used as raw materials for oxides of molybdenum.

The catalytic component used in the present invention may contain, as auxiliary catalysts or additives, oxides of P, oxides of S, oxides of Al (e.g., alumina), oxides of Si (e.g., glass fiber), oxides of Zr (e.g., zirconia), gypsum (e.g., dihydrate gypsum), zeolites, and the like. They can be used in the form of powder, sol, slurry, or fiber in the preparation of catalysts.

In the denitration catalyst structure of the present invention, the plurality of plate-like catalytic elements are housed in the frame body 5. Further, in the denitration catalyst structure of the present invention, the plurality of plate-like catalytic elements are stacked with their side edges aligned.

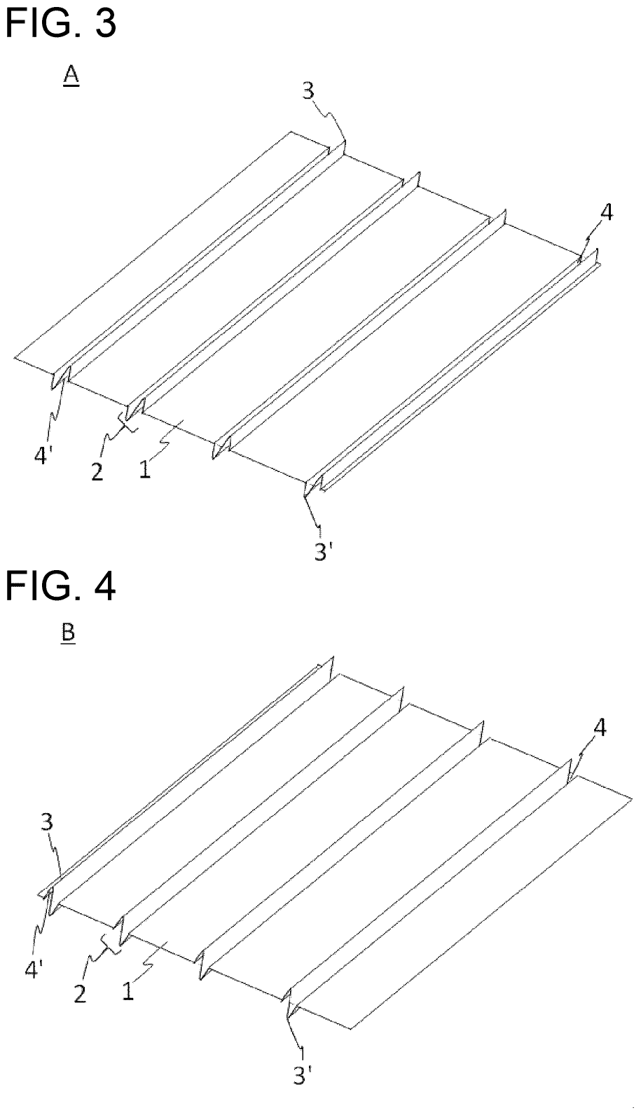

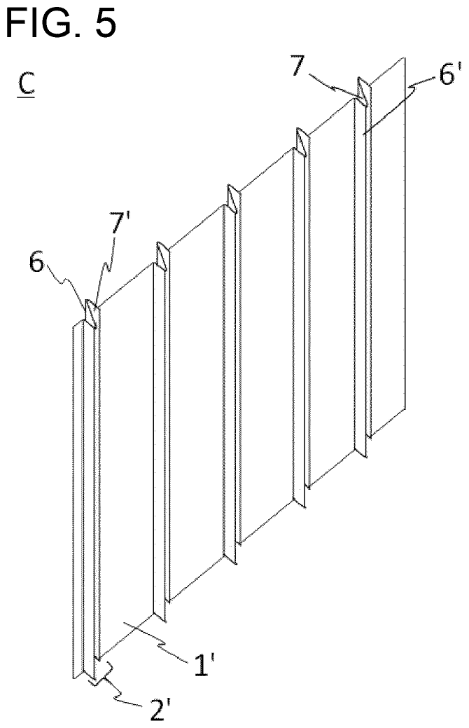

The plate-like catalytic elements should be able to provide a space for the inflowing gas to pass through when stacked. For example, the space for the inflowing gas can be provided by alternately stacking flat and corrugated plate-like catalytic elements, or alternately stacking plate-like catalytic elements as shown in FIGS. 3 and 4.

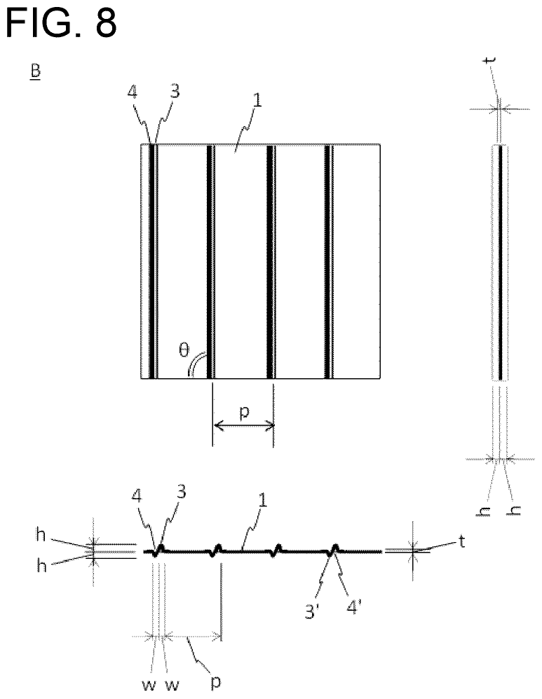

Each of the plate-like catalytic elements A, B shown in FIG. 3 or 4 has a plurality of alternating flat portions 1 and uneven portions 2. The flat portion 1 has a flat plate shape. The uneven portion 2 has a plate shape with parallel ridges 3, 3′ on the upper and lower surfaces. The ridges 3, 3′ may be curved, but it is preferable that they be substantially straight, as shown in FIG. 3, etc. The height h of the ridges 3, 3′ and the width w of the ridges 3, 3′ can be set as desired (see FIG. 8). The width of the uneven portion 2 is 2w. The reverse side of the individual ridges 3, 3′ is preferably grooves 4′, 4 in a shape corresponding to the ridges. Each uneven portion preferably has a Z-shaped or S-shaped cross-section with the ridge on the upper surface and the ridge on the lower surface. The thickness t in the flat and uneven portions of the plate-like catalytic element is not particularly limited, but is preferably 0.3 to 1.0 mm.

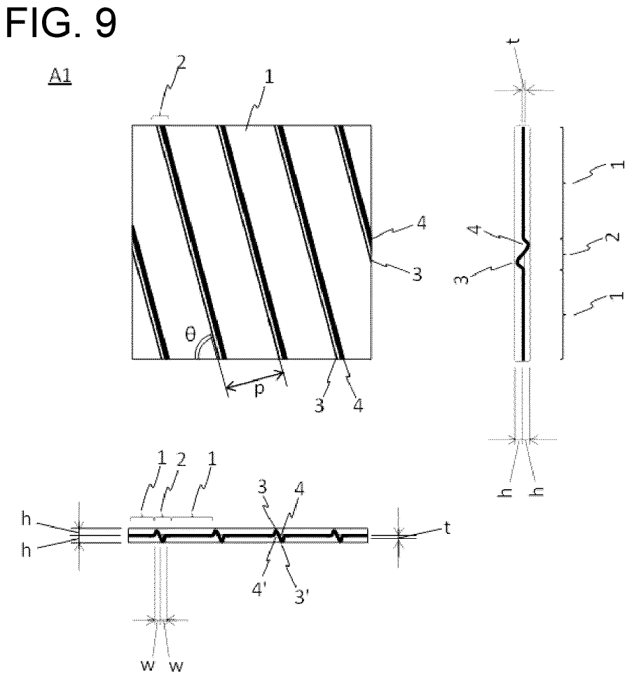

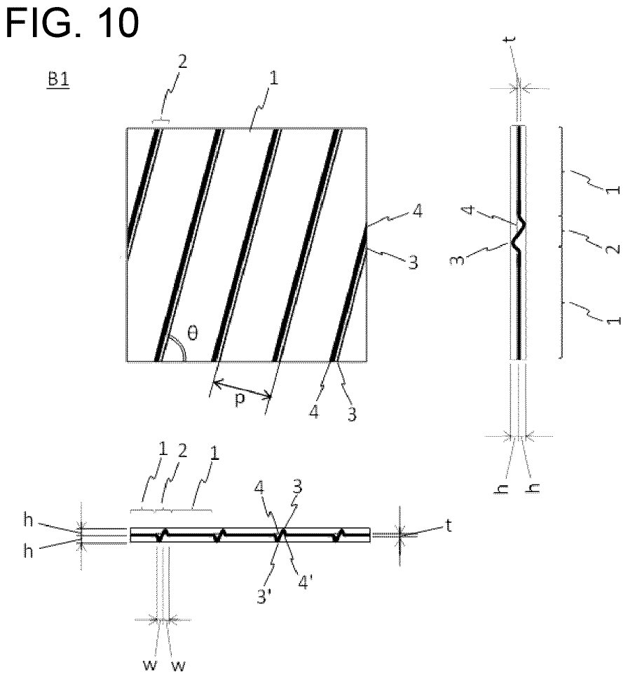

The longitudinal direction of each ridge of the plate-like catalytic element is preferably orthogonal or at an angle to the direction of extension of the gas inlet-side edge of the plate-like catalytic element (FIGS. 8, 9 and 10). The angle θ formed by the longitudinal direction of the ridges and the direction of extension of the gas inlet-side edge may be between 50 and 90 degrees, preferably between 55 and 90 degrees, more preferably between 65 and 90 degrees, even more preferably between 70 and 90 degrees. The smaller the angle θ, the more effective the increase in denitration rate tends to be. The larger the angle θ, the more effective the reduction in pressure loss tends to be. Parallel ridges on the same surface are preferably equally spaced. The distance p between the crest lines of parallel ridges on the same surface can be set as desired. In plate-like catalytic element, the smaller the distance p, the higher the denitration rate tends to be.

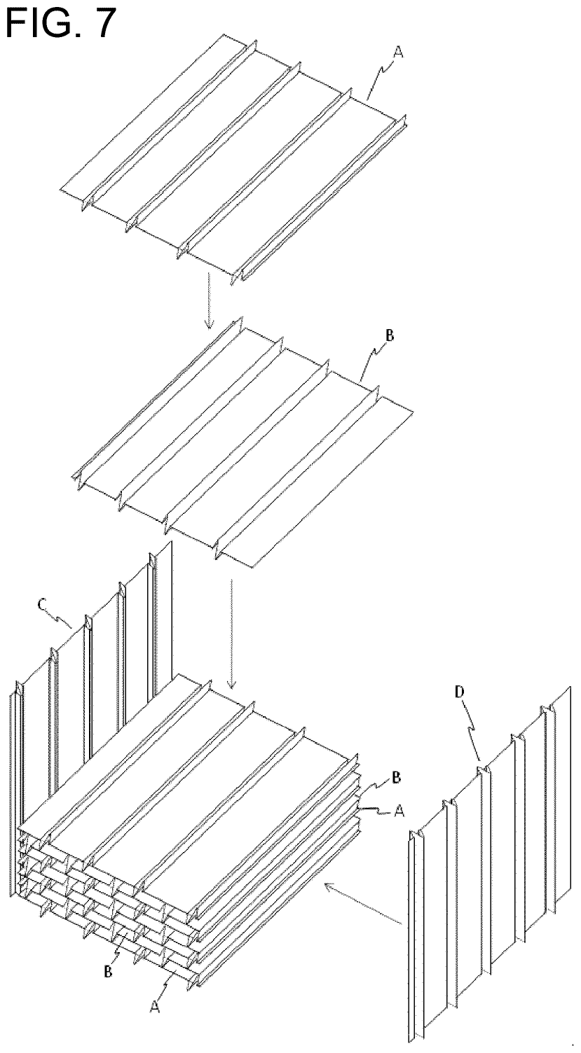

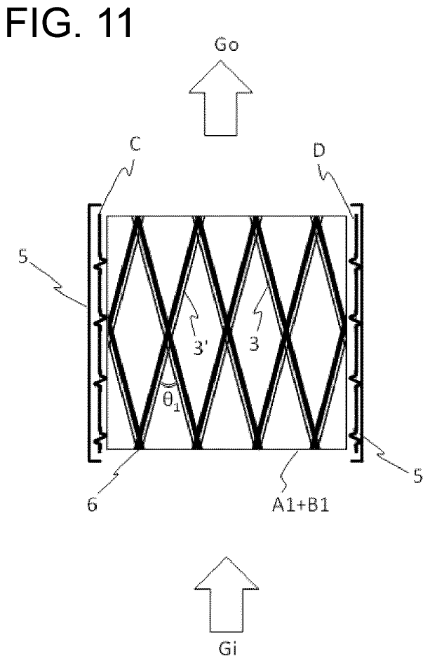

In the denitration catalyst structure of the present invention, the plate-like catalytic elements may be arranged such that the crest lines of ridges 3 on the upper surface of one plate-like catalytic element and the crest lines of ridges 3′ on the lower surface of another adjacent plate-like catalytic element intersect and touch each other as shown in FIG. 11, or the crest lines of ridges 3 on the upper surface or ridges 3′ on the lower surface of one plate-like catalytic element touch the flat portions of another adjacent plate-like catalytic element as shown in FIG. 7. When intersecting, the angle θ1 formed by the two crest lines at the intersection point is preferably between 10 and 80 degrees, more preferably between 20 and 70 degrees, even more preferably between 20 and 65 degrees (see FIG. 11).

When the plate-like catalytic elements are arranged, stacked, and housed in the frame body in this manner, a space is secured between the stacked plate-like catalytic elements and between the inner surface of the frame body and the edges of each plate-like catalytic element to allow a gas to pass from the gas inlet to the gas outlet through the space. The denitration reaction proceeds on the plate-like catalytic elements when the gas containing nitrogen oxides is brought into contact with the catalytic component contained in the plate-like catalytic elements. In this denitration reaction, a denitration agent such as ammonia may be added to the gas containing nitrogen oxides.

The plate-like draft stopper is plate-shaped with a gas inlet-side edge, a gas outlet-side edge, and two side edges. The overall shape of the plate-like draft stopper is preferably square or rectangular.

The plate-like draft stopper is arranged between the inner surface (right or left side surface) of the frame body and the side edges of each plate-like catalytic element so that the plate surface of the plate-like draft stopper follows the inner surface (right or left side surface) of the frame body. The plate-like draft stopper is not limited as long as it can be housed in the frame body and has a height (distance between the two side edges) that corresponds to the height of the frame body (distance between the upper and lower surfaces). The plate-like draft stopper may be as wide as the length from the inlet to the outlet of the frame body (distance between the gas inlet-side edge and the gas outlet-side edge), or it may be shorter than the length from the inlet to the outlet of the frame body.

The plate-like draft stopper has a mechanism which hinders the flow of gas passing between the inner surface of the frame body and the side edges of each plate-like catalytic element without stopping it. Examples of the mechanism on the plate surface of the plate-like draft stopper which hinders the flow of gas without stopping it include convex points (point-like projections) or concave points (point-like recesses) on the plate surface, a baffle plate on the plate surface, ridges or grooves with a cross-section of rectangular wave or sine wave shape obtained by bending the plate, and ridges or grooves with an S-shaped or Z-shaped cross-section obtained by bending the plate, as shown in FIG. 5.

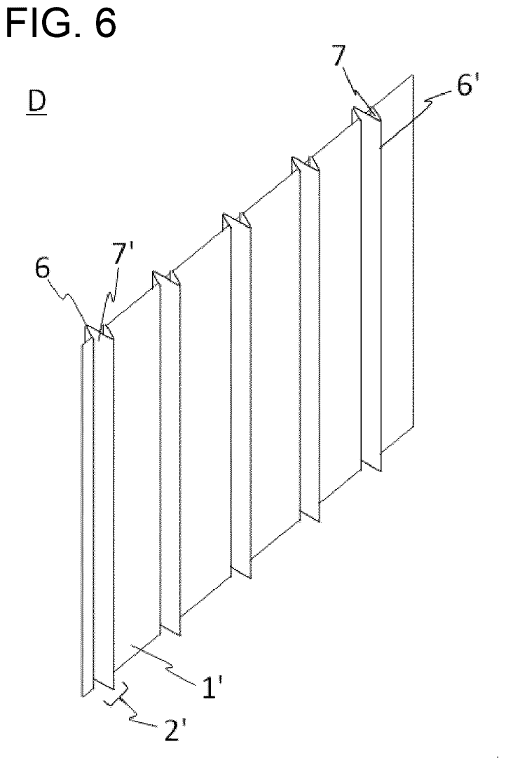

Each of the plate-like draft stoppers C, D shown in FIG. 5 or 6 has a plurality of alternating flat portions 1′ and uneven portions 2′. The flat portion 1′ has a flat plate shape. The uneven portion 2′ has a plate shape with parallel ridges 6, 6′ on the right and left surfaces. The ridges 6, 6′ may be curved, but it is preferable that they be substantially straight, as illustrated. The height h of the ridges 6, 6′ and the width w of the ridges 6, 6′ can be set as desired. The reverse side of the individual ridges 6, 6′ is preferably grooves 7′, 7 in a shape corresponding to the ridges. Each uneven portion preferably has a Z-shaped or S-shaped cross-section with the ridge on the right or left surface and the ridge on the left or right surface. For the plate-like draft stopper, the hindered gas flow tends to increase as the ratio h/w of height h to width w increases. The thickness t in the flat and uneven portions of the plate-like draft stopper is not particularly limited, but is preferably 0.3 to 1.0 mm.

By designing the maximum height difference 2h of the uneven portion 2′ of the plate-like draft stopper to correspond to the width of the space formed between the inner surface (right or left side surface) of the frame body and the side edges of each plate-like catalytic element, it is expected to have the effect of partially obstructing the flow of gas passing between the inner surface of the frame body and the side edges of each plate-like catalytic element. If the uneven portion 2′ of the plate-like draft stopper is sufficiently elastic, the movement of the plate-like catalytic elements within the frame body can be restricted, preventing harmful effects such as the plate-like catalytic elements being biased to one side.

Each ridge of the plate-like draft stopper is preferably arranged parallel or at an angle to the direction of extension of the gas inlet-side edge of the plate-like draft stopper. The angle formed by the longitudinal direction of the ridges and the direction of extension of the gas inlet-side edge may be between 0 and 40 degrees, preferably between 0 and 35 degrees, more preferably between 0 and 25 degrees, even more preferably between 0 and 20 degrees. Thus, the plate-like draft stopper housed in the frame body partially obstructs the gas flow passing between the inner surface of the frame body and the side edges of each plate-like catalytic element, reducing the proportion of the gas that flows out of the catalyst structure without ever coming into contact with the plate-like catalytic elements.

The plate-like draft stopper may contain a catalytic component. The method of containing the catalytic component is not limited. It can be contained in the same manner as the plate-like catalytic elements. For example, the plate-like draft stopper is preferably composed of a plate base material and a catalytic component carried on the surface thereof. Examples of the plate base material include lath plates, inorganic fiber woven fabrics, and non-woven fabrics. Expanded metal, perforated metal, and wire mesh can be used as the lath plates. The catalytic component can be carried by impregnation, coating, pressing, etc. The catalytic component is preferably carried on the plate base material so that the mesh of the plate base material, such as expanded metal, is blocked. The catalytic component contained in the plate-like draft stopper can be the same as those listed for the plate-like catalytic elements. When the plate-like draft stopper contains a catalytic component, the gas containing nitrogen oxides passing between the inner surface (right or left side surface) of the frame body and the side edges of each plate-like catalytic element can come into contact with the catalytic component in the plate-like draft stopper, allowing the denitration reaction to proceed even on the plate-like draft stopper.

In the drawings, one plate-like draft stopper is placed between the inner surface of the frame body and each side edge of each plate catalytic element, but a plurality of, e.g., two or three, plate-like draft stoppers may be placed on either side, as with the plate-like catalytic elements.

It is understood that the structure, shape, arrangement, etc., of the denitration catalyst structure of the present invention can be modified to the extent that it does not contradict the object of the invention, and that components and mechanisms used in the conventional technology can be added, and that such modifications or additions are within the technical scope of the invention.

### REFERENCE SIGNS LIST

9 Catalyst structure
1, 1′ Flat portion
2, 2′ Uneven portion
3 Ridge on upper surface
4 Groove on lower surface
3 Ridge on lower surface
4′ Groove on upper surface
5 Frame body
5a Flange
5b Hemming
6 Ridge on left surface
7 Groove on right surface
6′ Ridge on right surface
7 Groove on left surface
A, A1 Plate-like catalytic element
B, B1 Plate-like catalytic element
C Plate-like draft stopper
D Plate-like draft stopper
Gi Inflow gas
Go Outflow gas

1. A denitration catalyst structure, comprising:
a rectangular frame body having a gas inlet and a gas outlet;
a plurality of plate-like catalytic elements each of which has a gas inlet-side edge, a gas outlet-side edge, and two side edges and contains a catalytic component; and
a plate-like draft stopper having a gas inlet-side edge, a gas outlet-side edge, and two side edges,
wherein the plurality of plate-like catalytic elements are stacked and housed in the frame body with the side edges aligned, with a space between the stacked plate-like catalytic elements and between an inner surface of the frame body and the side edges of each plate-like catalytic element to allow a gas to pass from the gas inlet to the gas outlet through the space, and
wherein the plate-like draft stopper is arranged between the inner surface of the frame body and the side edges of each plate-like catalytic element so that a plate surface of the plate-like draft stopper follows the inner surface of the frame body, and the plate-like draft stopper has a mechanism which hinders a flow of the gas passing between the inner surface of the frame body and the side edges of each plate-like catalytic element without stopping the flow.

2. The denitration catalyst structure according to claim 1,
wherein the plate-like draft stopper contains a catalytic component.

3. The denitration catalyst structure according to claim 1,
wherein the mechanism which hinders the flow of the gas without stopping the flow is ridges arranged non-parallel to a gas flow direction on the plate surface of the plate-like draft stopper.
